(19) United States
(12) Patent Application Publication
(10) Pub. No.: US 2021/0067196 A1
(43) Pub. Date: Mar. 4, 2021

(54) Low Insertion Loss Network Device Having an Extended RF Spectrum

(71) Applicant: ATX Networks (Toronto) Corp., Toronto (CA)

(72) Inventor: Vito Alberto Orlando, Seattle, WA (US)

(21) Appl. No.: 17/003,916

(22) Filed: Aug. 26, 2020

Related U.S. Application Data
(60) Provisional application No. 62/892,245, filed on Aug. 27, 2019.

(51) Int. Cl. H04B 3/26; H04B 3/21; H04B 3/11

(52) U.S. Cl. CPC H04B 3/26; H04B 3/11; H04B 3/21

(57) ABSTRACT

A network device includes an interface configured to be coupled to a transmission line that simultaneously carries AC power and RF modulated content; content processing circuitry configured to route content communicated via the transmission line to one or more secondary network devices; and a component coupled to the interface to couple and decouple RF modulated content together with AC power communicated over the conductor extending the RF spectrum to 3 GHz. The component includes a core. The core includes a first portion having a conical geometry and a second portion having a cylindrical geometry. A wire makes a plurality of turns around the core starting from the first portion and ending in the second portion.

### RELATED APPLICATION

This application claims the benefit of U.S. Provisional Application No. 62/892,245 filed Aug. 27, 2019, which is incorporated herein in its entirety.

### FIELD OF THE INVENTION

This application generally relates to network equipment for the distribution of RF modulated data and audio/video content over a Hybrid Fiber Coaxial (HFC) cable network. In particular, this application describes a low insertion loss network equipment having an extended RF bandwidth.

### DESCRIPTION OF RELATED ART

Network devices that receive and transmit RF content and AC power over the same transmission line may utilize an AC/RF power passing choke filter to separate and combine the AC power component (below 60 Hz) from the RF signal component (greater than 5 MHz). Separation of the components facilitates processing of content within, for example, an HFC node or RF amplifier by presenting a low impedance to the 60 Hz AC power signal while simultaneously presenting a high impedance to the >5 MHz RF signal component, thereby directing and passing the AC power signal through the RF choke to the network device power supply while allowing the RF signal to pass to and from the network device RF processing circuitry.

Existing filters provide an RF passband from 5 MHz up to 1218 MHz with approximately 20 amperes of AC current capacity. However to support the continued demand for increased speed and capacity of transmitting and receiving data from network subscribers, the upper RF passband limit will need to increase from 1218 MHz to up to 3 GHz or greater.

The choke utilized in the filter to separate and combine the AC and RF signal is an inductor capable of handling the relatively high amount of current required to power the network devices.

The operating bandwidth of a typical inductor may be increased by reducing its outer diameter of its core, the number of wire turns wrapped around the core and/or by reducing the inter winding capacitance between loops of the wire in proportion to the wire size and the outer diameter.

However, increasing the bandwidth of a choke is difficult given the relatively high current carrying requirements of the choke. A reduction in the outer diameter of the core and/or the wire, or of the wire size may not be feasible because such changes may increase the flux density of the core and result in core saturation at high current. This in turn may influence the RF signal with an impedance that varies with the frequency of changes in the AC power signal resulting in a distortion of the RF signal referred to as Hum Modulation.

These and other problems with existing chokes will become apparent upon reading the specification.

### SUMMARY

A network device includes a) an interface configured to be coupled to a coaxial transmission line that simultaneously carries AC power and RF modulated content; b) content processing circuitry configured to route content and power communicated via the transmission line to one or more secondary network devices; and c) a choke coupled to the interface to route power communicated over the conductor to the internal power supply circuitry to facilitate powering the content processing circuitry within the network device. The choke includes a core. The core includes a first portion having a conical geometry and a second portion having a cylindrical geometry. A wire makes a plurality of turns around the core starting from the first portion and ending in the second portion.

A passive electrical component includes a core. The core includes a first portion having a conical geometry and a second portion having a cylindrical geometry. A wire makes a plurality of turns around the core starting from the first portion and ending in the second portion.

### BRIEF DESCRIPTION OF THE DRAWINGS

FIG. 1 illustrates an exemplary network device coupled to a provider network;

FIG. 2A is a side view of an exemplary choke used in an embodiment of the network device;

FIG. 2B is a top view of the exemplary choke;

FIG. 3 is a cross section of the choke taken along section A-A′ of FIG. 2B;

FIG. 4 is a graph that illustrates the bandwidth of a network device using a standard choke; and

FIG. 5 is a graph that illustrates the bandwidth of a network device using the choke of FIGS. 2A, 2B, and 3.

### DETAILED DESCRIPTION

The problems described above are overcome by providing a network device that includes a choke optimized to support the evolution of HFC networks from 1.2 GHz to 1.8 GHz and beyond to 3 GHz.

The challenges/tradeoffs in designing an AC power choke for low insertion loss, a 5 MHz to 3 GHz extended RF spectrum with a relatively flat frequency response, a current capacity of 20 amperes, and low hum modulation include several conflicting considerations. For example, a choke that has too much inductance may cause resonances at high RF frequencies because of the stray capacitance combined with the inductance of the choke. The LC resonances may fall within the desired frequency range causing an increased insertion loss at those resonance points degrading the RF signal. However, too little inductance results in excessive insertion loss at low RF frequencies.

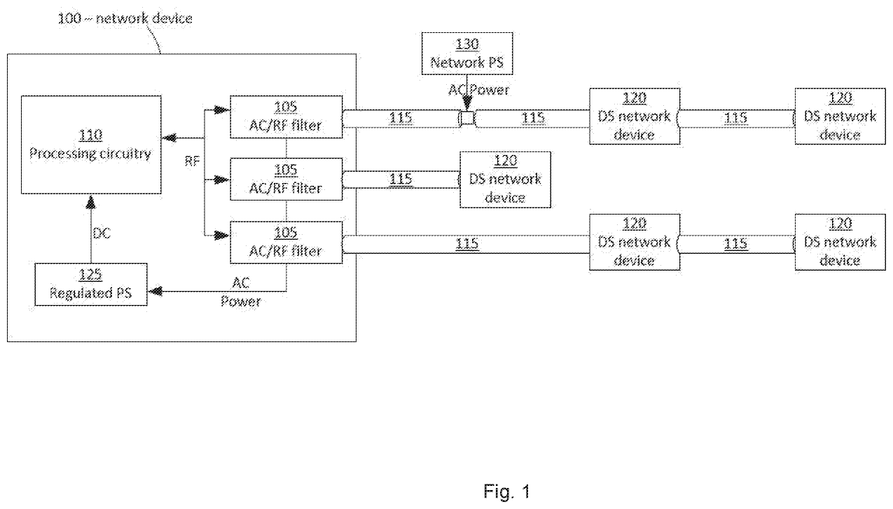

FIG. 1 illustrates an exemplary network device 100 according to an embodiment. The network device 100 may correspond to an optical/RF node or distribution amplifier for amplifying and redirecting signals communicated over a transmission line such as the coaxial cable provided by a cable operator (i.e., provider cable 115) to one or more downstream network devices 120.

In addition to the RF content, AC power may be provided over the provider cable 115 from a network power supply 130 to power the network device 100 and other network devices 120. In this regard, voltage present on the provider cable 115 may be generally unregulated and may, for example, be anywhere between 30 and 95 volts AC. The network device 100 may include power regulation circuitry 125 that converts the AC unregulated voltage to one or more DC regulated voltages that are in turn utilized to power other circuitry 110 of the network device 100. For example, the power regulation circuitry 125 may include various switching and linear power regulators for converting the AC unregulated voltage to a regulated DC voltage.

In an embodiment, the network device 100 includes an AC/RF filter 105 that includes a choke that exhibits an inductance in the order of 5 uH to couple and decouple the AC power with the RF content signal to and from the provider cables 115 and direct AC power to the power regulation circuitry 125 associated with the network device 100. In this regard, the AC/RF filter 105 facilitates an increase in RF spectrum capability to 3 GHz while maintaining adequate RF performance characteristics of insertion loss, frequency response, and low frequency noise generation. Moreover, the AC/RF filter 105 is rated to handle, for example, in the range of 20 amperes to facilitate routing AC power from the AC power source 130 to the network device 100 power supply 125 and to a plurality of network devices 120 connected by provider cable 115.

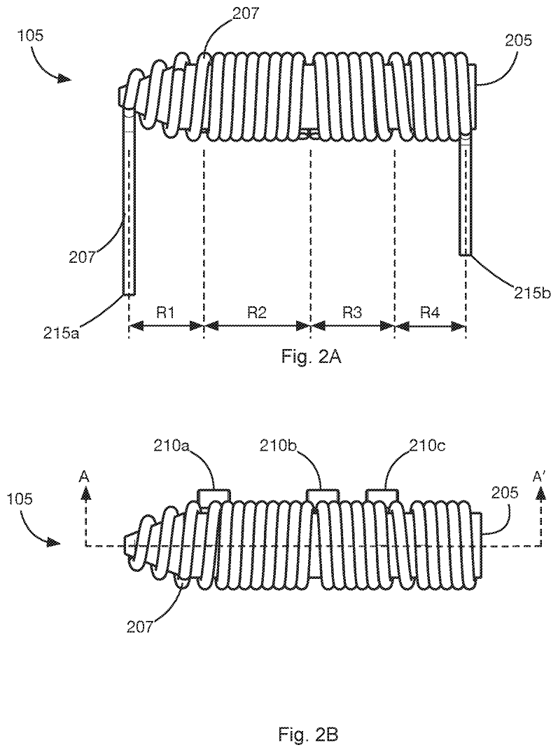

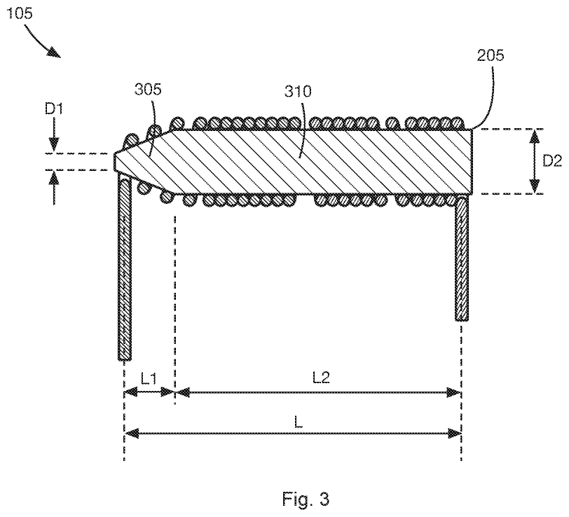

FIGS. 2A, 2B, and 3 illustrate views of an exemplary choke that in an embodiment corresponds to a component in AC/RF filter 105 of FIG. 1. As shown, the component includes a core 205, a wire 207 that is wrapped around the core 205, a pair of legs (215a and 215b) for soldering the component 105 to a circuit board, and a group of passive elements (210a, 210b, and 210c). In an implementation, the core 205 may be formed from a ferrite material having magnetic characteristics. The gauge of the wire 207 may be between 12 and 18 AWG to facilitate carrying current in the range of >1 to 25 amperes. The number of passive elements 210 may be decreased or increased and not explicitly limited to a group of three.

As shown more clearly in FIG. 3. The core 205 includes a first portion 305 having a conical geometry and a second portion 310 having a cylindrical geometry. In one implementation, the overall length of the core, L, in the longitudinal direction may be about 1″ to 1.5″. The length, L1, of the first portion 305 may be about 0.2″ to 0.7″, and the length, L2, of the second portion 310 may be about 0.8″ to 1.3″. The apex of the first portion 305 may have a diameter, 01, of about 0.05″ to 0.1″, and the diameter of the second portion 310, 02, may be about 0.2″ to 0.4″. These dimensions result in the first portion 305 having a surface that tapers from the apex towards the second portion 310 at an angle of about 15° to 25°.

Referring back to FIGS. 2A and 2B, the number of turns the wire 207 makes around the core may vary over different regions of the core. For example, in a first region, R1, that corresponds generally to the first portion of the core 205, the wire may make 1 to 4 turns. In a second region, R2, the wire may make 1 to 4 turns. In a third region, R3, the wire may make 3 to 6 turns. And in a fourth region, R4, the wire may make 6 to 13 turns. As noted, the length in the longitudinal direction of the first region, R1, corresponds generally to the length of the first portion 305 (FIG. 3). The length of the second region, R2, may be about 0.1″ to 0.3″. The length of the third region, R3, may be about 0.2″ to 0.4″. And the length of the fourth region, R4, may be about 0.5″ to 0.7″. The number of regions, various lengths and number of turns, wire gauge, etc. may be different and may be selected to provide a suitable inductance and frequency response for a given application.

In an embodiment, the wire 207 turns around the core 205 in a first direction in regions R1 and R2, and turns around the core 205 in an opposite direction in regions R3 and R4 to form an inductor having a series opposing connection in which the mutually induced electromotive force (emf) opposes the self-induced emf.

As shown in FIG. 2B, the passive elements (210a, b, and c) may connect turns between the different regions. For example, a first passive element 210a may bridge a turn in the first region, R1, with a turn in the second region, R2. A second passive element 210b may bridge a turn in the second region, R2, with a turn in the third region, R3. And a third passive element 210c may bridge a turn in the third region, R3, with a turn in the fourth region, R4. In an implementation, the number of passive elements may differ and correspond to resistors with a value of 100 to 1800 ohms.

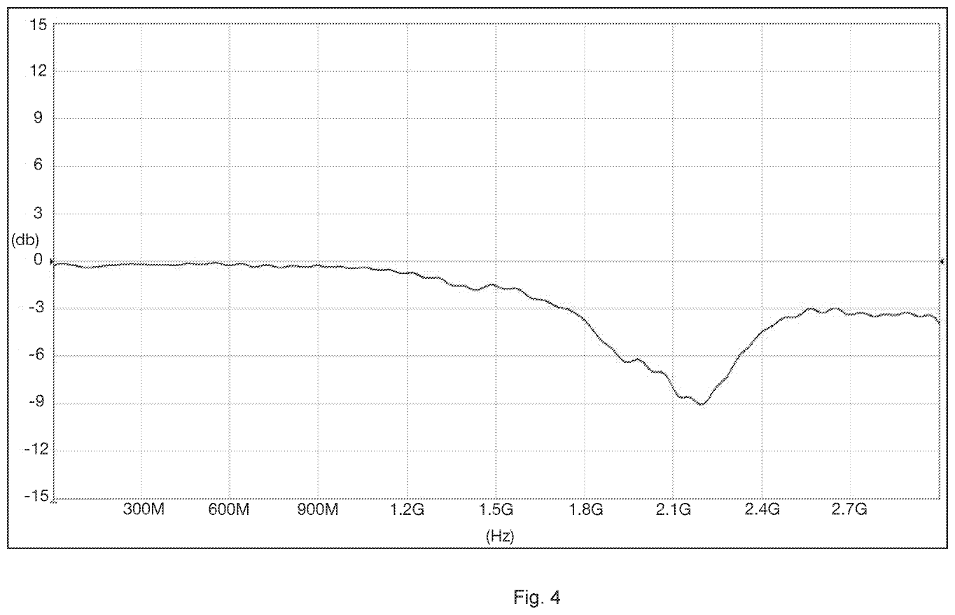

In operation, the conic structure of the winding on the initial portion of the ferrite core builds enough impedance without self-resonance and effectively reduces the insertion loss of the network device, thereby expanding the bandwidth without significantly impacting the overall inductance of the component 105. For example, as shown in FIG. 4, a network device using a choke having a cylindrical ferrite core choke may exhibit an insertion loss of about −3 dB at about 1.8 GHz along with a significant attenuation and deviation in frequency response between 1.8 GHz and 2.4 GHz, effectively limiting the network device to frequencies below 1.8 GHz. In addition, a hum-modulation of the network device can be below −65 dBc.

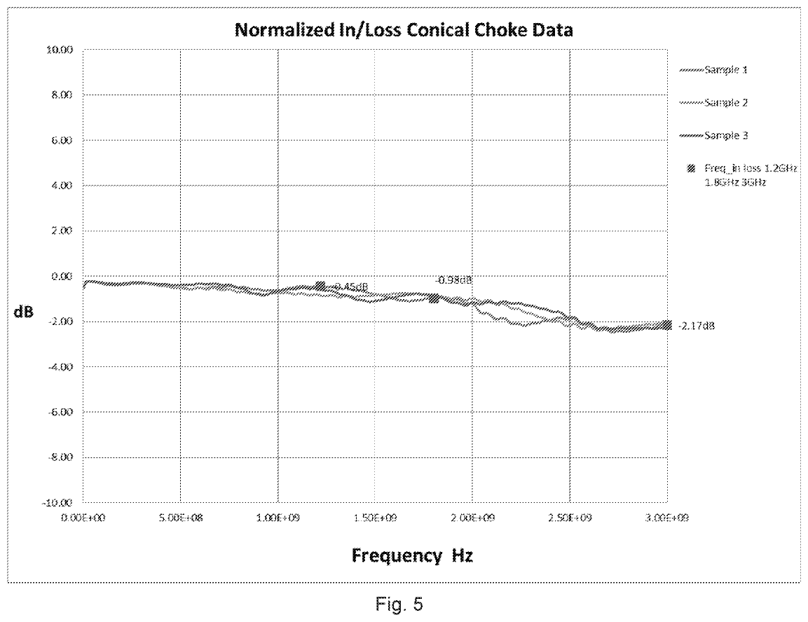

Referring to FIG. 5, on the other hand, a network device using a choke having the conical ferrite core choke described above may exhibit a monotonic insertion loss of about <3 dB at about 3.0 GHz, increasing the effective bandwidth of the network device to 3 GHz.

While network device and component used therein have been described with reference to certain embodiments, it will be understood by those skilled in the art that various changes may be made and equivalents may be substituted without departing from the scope of the claims. Therefore, it is intended that the present methods and systems not be limited to the particular embodiment disclosed, but that the disclosed methods and systems include all embodiments falling within the scope of the appended claims.

What is claimed is:

1. A network device comprising:
an interface configured to be coupled to a transmission line that simultaneously carries power and RF modulated content;
content processing circuitry configured to route content communicated via the transmission line to one or more secondary network devices; and
a component coupled to the interface to couple and decouple RF modulated content together with AC power communicated over the transmission line wherein the component includes:
a core that includes a first portion having a conical geometry and a second portion having a cylindrical geometry; and
a wire that makes a plurality of turns around the core starting from the first portion and ending in the second portion.

2. The network device according to claim 1, wherein core has a total length of between 1.0″ and 1.5″ in a longitudinal direction, wherein the length of the first region is between 0.2″ to 0.7″.

3. The network device according to claim 2, wherein an apex of the first portion has a diameter of about 0.05″ to 0.1″, and wherein the second portion has a diameter of about 0.2″ to 0.4″.

4. The network device according to claim 2, wherein the number of turns the wire makes around the core varies over different regions of the core, wherein in a first region that corresponds to the first portion, the wire makes 1-4 turns, in a second region the wire makes 1-4 turns, in a third region the wire makes 3-6 turns, and in a fourth region the wire makes 6-13, wherein a length of the first region corresponds to the length of the first portion, a length of the second region is about 0.1″ to 0.3″, a length of the third region is about 0.2″ to 0.4, and a length of the fourth region is about 0.5″ to 0.7″.

5. The network device according to claim 4, wherein a first passive element bridges a turn in the first region with a turn in the second region, a second passive element bridges a turn in the second region with a turn in the third region, and a third passive element bridges a turn in the third region with a turn in the fourth region.

6. The network device according to claim 1, wherein a current flowing through the component during operation of the network device is greater than 20 amperes.

7. The network device according to claim 1, wherein a hum-modulation of the network device is below −65 dBc.

8. The network device according to claim 1, wherein the network device has a monotonic insertion loss of less than 3 dB at 3 GHz.

9. A passive electrical component comprising:
a core that includes a first portion having a conical geometry and a second portion having a cylindrical geometry; and
a wire that makes a plurality of turns around the core starting from the first portion and ending in the second portion.

10. The passive electrical component according to claim 9, wherein core has a total length of between 1.0″ to 1.5″ in a longitudinal direction, wherein the length of the first region is between 0.2″ to 0.7″.

11. The passive electrical component according to claim 10, wherein an apex of the first portion has a diameter of about 0.05″ to 0.1″, and wherein the second portion has a diameter of about 0.2″ to 0.4″.

12. The passive electrical component according to claim 10, wherein the number of turns the wire makes around the core varies over different regions of the core, wherein in a first region that corresponds to the first portion, the wire makes 1-4 turns, in a second region the wire makes 1-4 turns, in a third region the wire makes 3-6 turns, and in a fourth region the wire makes 6-13, wherein a length of the first region corresponds to the length of the first portion, a length of the second region is about 0.1″ to 0.3″, a length of the third region is about 0.2″ to 0.4, and a length of the fourth region is about 0.5″ to 0.7″.

13. The passive electrical component according to claim 12, wherein a first passive element bridges a turn in the first region with a turn in the second region, a second passive element bridges a turn in the second region with a turn in the third region, and a third passive element bridges a turn in the third region with a turn in the fourth region.
